(19) United States
(12) Patent Application Publication
(10) Pub. No.: US 2003/0023411 A1
(43) Pub. Date: Jan. 30, 2003

(54) Methods for facilitating the design and installation of custom home networking systems

(76) Inventors: Don Witmer, San Jose, CA (US); William Skip Marsh, Gilroy, CA (US)

Correspondence Address: MYERS BIGEL SIBLEY & SAJOVEC, PO BOX 37428, RALEIGH, NC, 27627, US

(21) Appl. No.: 09/840,742

(22) Filed: Apr. 23, 2001

(51) Int. Cl. G06F 17/50

(52) U.S. Cl. 703/1

(57) ABSTRACT

Methods of facilitating the design and installation of custom home networking systems within new and existing homes are provided. Information about a particular home design is obtained by an intermediary from floor plans. The intermediary designs a home networking system infrastructure for the home using information obtained from the floor plans. The home networking system infrastructure includes the layout and arrangement of a plurality of communications cables that extend from a network connection center to be located within the home and that terminate at respective outlets or devices to be located in one or more rooms of the home. The home networking system infrastructure also includes various types of outlets that are associated with communications and entertainment systems, such as telephone jacks, universal outlets, TV jacks, and speaker jacks. The home networking system infrastructure is configured to support various home networking system configurations that are selected by a homeowner. The intermediary then presents the designed home networking system infrastructure to the homeowner via a workbook that includes descriptions of the various home networking system options that are supported by the home networking system infrastructure. Using the workbook, the homeowner can select from various telecommunications options, various entertainment options, and various security options to produce a custom home networking system for the home.

### FIELD OF THE INVENTION

The present invention relates to selecting and installing telecommunications, entertainment, and security systems in new and existing homes.

### BACKGROUND OF THE INVENTION

Increasingly, existing homes and homes under construction are being “networked” wherein communications cables (video, data, and telecommunications cables) are being extended to many rooms and, in some cases, to multiple locations within a room. The benefits of “home networking” may include the ability to network multiple computers, printers and peripherals throughout a home and to access the Internet through a single high-speed connection; to watch an internally modulated video signal such as a video cassette recorder (VCR), digital video disk (DVD), or satellite television receiver from any room in the home; to use a digital phone system, such as an ISDN line, throughout the home; to add security video cameras in the home and view them on any television; and to add future equipment that may allow a homeowner to use the same hand-held remote control in any room.

Home networking typically requires the use of a central distribution panel which serves as a gateway or interface to various communications, entertainment, and/or security services. Within these central distribution panels, cable distribution modules are typically utilized to receive a cable from a service provider and distribute the service provided among various communications cables that are routed throughout the home. For example, a video cable distribution module may be configured to receive a cable from a cable TV service provider and distribute the signal to multiple cables routed within a home. Cable distribution modules may be amplified or non-amplified to divide signals to multiple communications cables, depending upon the number of communications cables involved.

An exemplary central distribution panel 10 is illustrated in FIG. 1. With the exception of electric power, communications services entering a home are typically routed into the central distribution panel 10. From the central distribution panel 10, distribution cables 12 and, consequently, the services they provide, are routed to wall taps (outlets) or devices in various locations throughout a home. Conventionally, the service provided at a particular outlet or device is determined by the cable's connection in the central distribution panel 10. For example, if an outlet is connected to a computer networking hub, a computer networking service is provided at the outlet. By moving the connection in the central distribution panel 10 from the computer networking hub to a telecommunications module, the service at the outlet may be changed to telephone service.

The emergence of home networking and its rapid adoption by home owners has placed a new set of demands on builders, architects and designers of homes (collectively referred to herein as “home builders”). Conventionally, separate contractors are utilized to design and install security systems, telecommunication systems and entertainment systems, respectively, within a home. With regard to new construction, each separate contractor coordinates its respective schedule with that of a home builder. Because of the additional coordination which may be required because of multiple contractors, and because of the potential for disruption to a construction schedule, home builders may be reluctant to offer home networking systems to home buyers.

In addition, standards may not exist for the design and installation of home networking systems, particularly with respect to low voltage wiring. For example, the design and installation of traditional electrical wiring, plumbing, and structural portions of a home are performed according to well known standards. Because of the lack of standards, home networking installations may be inconsistent from one home to the next. Also, home builders may not have sufficient knowledge of the various home networking technologies desired by home buyers.

### SUMMARY OF THE INVENTION

In view of the above discussion, methods of facilitating the design and installation of custom home networking systems within new and existing homes are provided. Information about a particular home design is obtained by an intermediary from floor plans (and/or other construction drawings/materials). The intermediary designs a home networking system infrastructure for the home using information obtained from the floor plans. Both objective and subjective information is obtained from the floor plans. Objective information includes information associated with measurable, physical parameters in the floor plans. Subjective information includes information that is interpreted by the intermediary as being relevant to a custom home networking system for a particular home design, such as the arrangement and type of rooms in the floor plans.

The home networking system infrastructure designed by the intermediary includes the layout and arrangement of a plurality of communications cables that extend from a network connection center to be located within the home and that terminate at respective outlets or devices to be located in one or more rooms of the home. The home networking system infrastructure also includes various types of outlets that are associated with communications and entertainment systems, such as telephone jacks, universal outlets, TV jacks, and speaker jacks. The home networking system infrastructure is configured to support various home networking system configurations that are selected by a homeowner.

The intermediary then presents the designed home networking system infrastructure to the homeowner via a workbook that includes descriptions of the various home networking system options that are supported by the home networking system infrastructure. The workbook includes a set of low voltage wiring diagrams for the home that identify the location of a central distribution panel (referred to hereinafter as a “network connection center”) in the home and the locations and types of outlets and devices to be connected by cables and wires extending from the network connection center. The workbook also may include a price list for the available home networking system options described therewithin. Using the workbook, the homeowner can select from various telecommunications options, various entertainment options, and various security options to produce a custom home networking system for the home.

For new construction, the intermediary may provide a builder with cost information associated with installing the custom home networking system within a particular home and may integrate a schedule for installing the custom home networking system into the builder's construction schedule. The intermediary may also monitor installation of a custom home networking system for a particular home for compliance with regulations and standards, and with various schedules. For existing homes, the intermediary may act on behalf of the homeowner and coordinate installation of the custom home networking system with an installer. The intermediary may also monitor installation of the custom home networking system for compliance with regulations and standards, and/or with various schedules.

Upon installation of a custom home networking system, the intermediary facilitates the activation of components and/or services of the installed custom home networking system and may also provide the homeowner with an owner's manual contains information (e.g., operational information, warranty information, trouble shooting information, etc.) about the custom home networking system.

Embodiments of the present invention permit home networking systems to be selected, customized, and installed without disrupting the construction schedules of builders. Moreover, builders are not required to have detailed knowledge of the various components of home networking systems and need not become involved in the design and layout thereof. In addition, embodiments of the present invention facilitate the standardization of designing and installing custom home networking systems. As such, the installation of home networking systems can be consistent from one home to the next.

### BRIEF DESCRIPTION OF THE DRAWINGS

FIG. 1 is front elevational view of an exemplary conventional cable distribution panel (network connection center) from which communications cables are routed to various outlets or devices of a home networking system.

FIG. 2A is a flow chart that illustrates methods of facilitating the design and installation of custom home networking systems within new homes, according to embodiments of the present invention.

FIG. 2B is a flow chart that illustrates methods of facilitating the design and installation of custom home networking systems within existing homes, according to embodiments of the present invention.

FIG. 3 is an exemplary template into which objective and subjective information is input to produce a home networking system infrastructure, according to embodiments of the present invention.

FIG. 4 is a floor plan for a portion of a home.

FIG. 5 is a low voltage wiring diagram that schematically represents a home networking system infrastructure for the floor plan of FIG. 4.

FIGS. 6A-6C provide keys for the various types of outlets and devices associated with the home networking system infrastructure of FIG. 4.

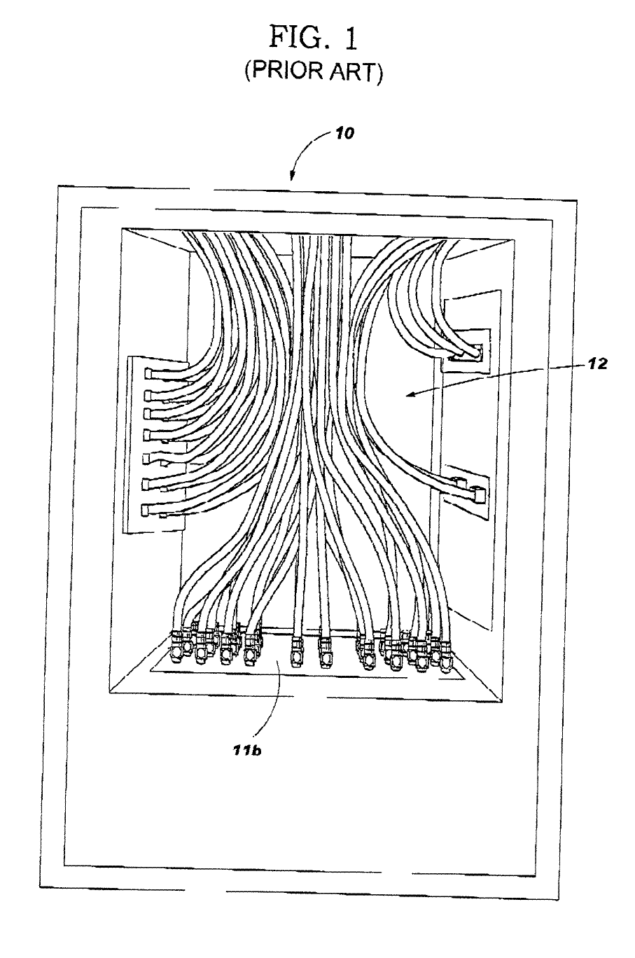

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

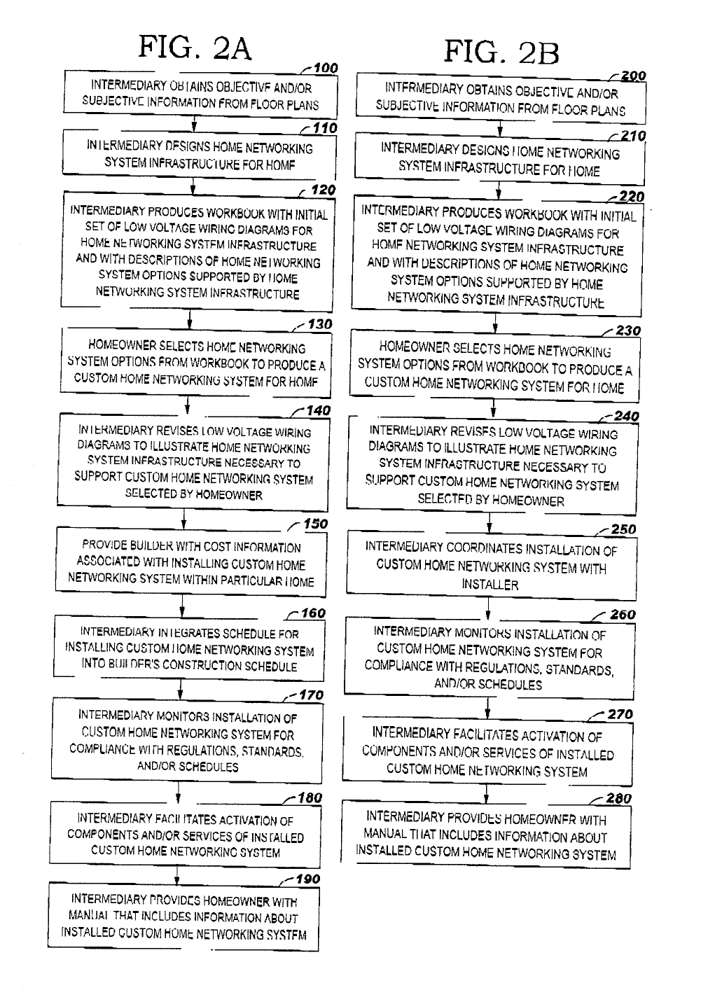

Referring now to FIG. 2A, methods of facilitating the design and installation of custom home networking systems within new homes, according to embodiments of the present invention, will be described. Initially, an intermediary obtains various information from floor plans (or other drawings/materials) for a particular home (or for a particular home design) (Block 100). Both objective and subjective information can be obtained. Objective information refers to information associated with measurable, physical parameters (e.g., anything that can be physically measured) including, but not limited to, the number of doors in each room, the number of windows in each room, physical dimensions of each room, etc. Subjective information refers to information that is interpreted by a third party (e.g., the intermediary) as being relevant to a custom home networking system for a particular home (or home design). For example, information such as the recognition that two particular rooms are adjacent in a floor plan may have relevancy to the type of home networking system infrastructure and subsequent custom home networking system that can be installed in a home having this particular design. Other examples include the intended use of rooms (e.g., a den that also is going to be used as a bedroom), and the locations of various devices, including speakers, volume controls, and security system features (e.g., motion detectors for doors, and keypads).

Utilizing information obtained from the floor plans for a particular home (or particular home design), the intermediary designs a home networking system infrastructure for the home (Block 110). According to embodiments of the present invention, subjective and objective information obtained from the floor plans is entered into a data processing system via one or more input templates. The data processing system then produces a home networking system infrastructure (or portions thereof) which may be considered appropriate for the particular home (or home design) based upon the various objective and subjective information.

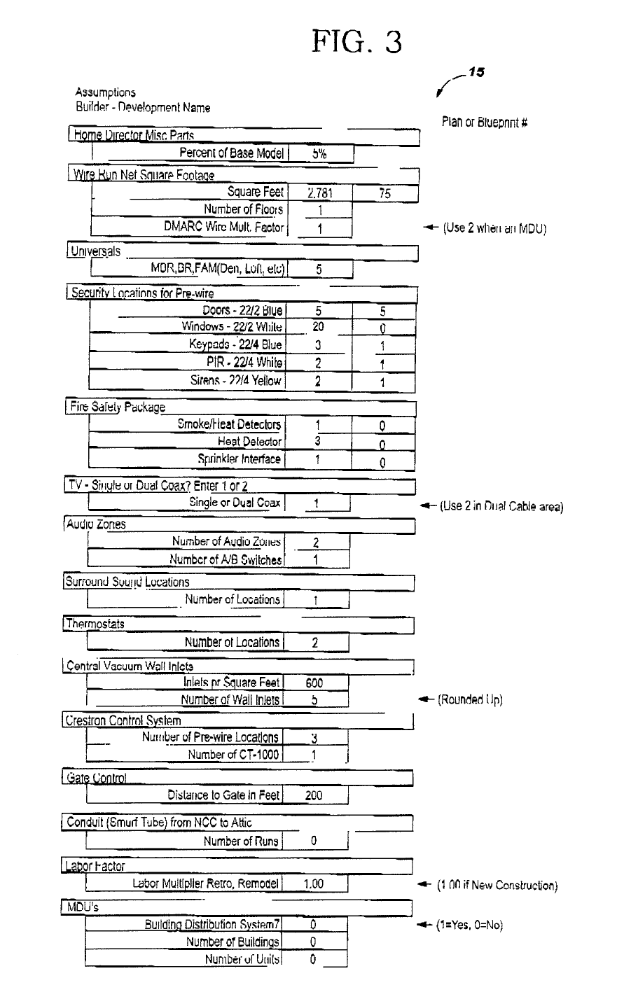

An exemplary template 15 into which objective and subjective information may be input into a data processing system to produce a home networking system infrastructure, according to embodiments of the present invention, is illustrated in FIG. 3. Various templates may be utilized. The present invention is not limited to the illustrated template 15. In addition, it is understood that a data processing system is not required for producing a home networking system infrastructure. An intermediary may utilize various objective and subjective information and design a home networking system infrastructure without the aid of a data processing system.

The home networking system infrastructure designed by the intermediary includes the layout and arrangement of a plurality of communications cables that extend from a network connection center to be located within the home and that terminate at respective outlets or devices to be located in one or more rooms of the home. An exemplary network connection center is described in co-assigned and co-pending U.S. patent application Ser. No. 09/621,434, which is incorporated herein by reference in its entirety. The home networking system infrastructure includes various types of outlets that are associated with communications and entertainment systems, such as telephone jacks, universal outlets, TV jacks, and speaker jacks. The home networking system infrastructure is configured to support various home networking system configurations that are selected by a homeowner.

According to embodiments of the present invention, the intermediary produces a document referred to as a “workbook” that describes and/or illustrates the home networking system infrastructure for a particular new home design and that includes descriptions of the various home networking system options that can be supported by the home networking system infrastructure (Block 120). Selectable home networking system options may include various telecommunications devices and services, and/or entertainment devices and services, and/or security devices and services. The workbook preferably includes an initial set of one or more low voltage wiring diagrams for the particular home (or home design) that illustrate the home networking system infrastructure. Specifically, the low voltage wiring diagrams identify the location within the home of a network connection center from which various communications cables are to be distributed throughout the home. In addition, the low voltage wiring diagrams include the locations and types of outlets and devices within the various rooms of the home and at which a respective communications cable routed from the network connection center terminates.

To assist a homeowner in selecting options, the workbook may include price lists for the available home networking system options that are supported by the home networking system infrastructure. The workbook may also include various other information that can be helpful to a homeowner is selecting options and coordinating installation of a custom home networking system.

The intermediary allows a homeowner to select home networking system options from the workbook to produce a custom home networking system for the home (Block 130). The intermediary produces a revised set of low voltage wiring diagrams illustrating a home networking system infrastructure necessary to support the custom home networking system for the home (Block 140). For example, the homeowner may not choose a device or system to be connected to every possible outlet set forth in the initial low voltage wiring diagrams.

According to embodiments of the present invention, the intermediary may also provide a builder with cost information associated with installing a custom home networking system within a particular home (Block 150). Cost information provided to a builder may include a bill of materials and a price list for a particular custom home networking system.

According to embodiments of the present invention, the intermediary may integrate a schedule for installing a custom home networking system into a builder's construction schedule for a particular home (Block 160). The intermediary may also monitor installation of a custom home networking system for a particular home for compliance with regulations and standards, and with various schedules (Block 170).

Upon installation of a custom home networking system, the intermediary facilitates the activation of components and/or services of the installed custom home networking system (Block 180). The intermediary may also provide a homeowner with an owner's manual for a custom home networking system that provides information (e.g., operational information, warranty information, trouble shooting information, etc.) about the custom home networking system (Block 190).

Method steps described above with respect to FIG. 2A may be repeated for a plurality of homes being built by a builder within a subdivision. For example, an intermediary may enter into an agreement with a builder to be the provider of custom home networking systems for homes in the subdivision. The intermediary obtains the floor plans for each home design being built in the subdivision and extracts objective and subjective information therefrom. Using the extracted information, the intermediary produces a home networking system infrastructure for each home design.

The intermediary produces a proposal for the builder which includes for each home design, a respective bill of materials, price list, and preliminary set of low voltage wiring diagrams which schematically illustrate a respective home networking system infrastructure for a particular home design. As described above, the low voltage wiring diagrams identify the location of a network connection center from which various communications cables are to be distributed throughout a home. In addition, the low voltage wiring diagrams include the locations and types of outlets and devices within the various rooms of a home and at which a respective communications cable routed from the network connection center terminates.

If the builder authorizes the intermediary to proceed, the intermediary prepares a workbook (also referred to as a “Welcome Package”) for each respective homeowner in the subdivision. The workbook contains information about the various telecommunications, entertainment, and security options that are available for the homeowner's respective home. The workbook may include price lists for the available home networking system options that are supported by the home networking system infrastructure. The workbook may also include various other information that can be helpful to a homeowner is selecting options and coordinating installation of a custom home networking system. In addition, a home networking system designer may meet with each homeowner to assist the homeowner in customizing a home networking system.

Once a homeowner has selected a custom home networking system, the intermediary coordinates installation of the custom home networking system with the builder. The intermediary integrates the schedules of installers with the schedule of the builder for each respective home. In addition, the intermediary may monitor the installation of a custom home networking system in each respective home.

Referring now to FIG. 2B, methods of facilitating the design and installation of custom home networking systems within existing homes, according to embodiments of the present invention, will be described. Initially, an intermediary obtains various information from floor plans (or other drawings/materials) for an existing home (Block 200), for example, from a homeowner. As described above, information obtained from the floor plans may include objective information and subjective information. The intermediary designs a home networking system infrastructure for the existing home using the information obtained from the floor plans (Block 210), and with or without the aid of a data processing system.

As described above, the home networking system infrastructure designed by the intermediary includes a layout and arrangement of a plurality of communications cables that extend from a network connection center to be located within the home to respective outlets or devices to be located in one or more rooms of the home. The home networking system infrastructure includes outlets associated with communications and entertainment systems, such as telephone jacks, universal outlets, TV jacks, and speaker jacks. The home networking system infrastructure is configured to support various home networking system options that are selected by a homeowner.

As described above, the intermediary may produce a workbook that describes and/or illustrates the home networking system infrastructure, and that also describes various home networking system options that can be supported by the home networking system infrastructure (Block 220). Selectable home networking system options may include telecommunications devices and services, and/or entertainment devices and services, and/or security devices and services. The workbook preferably includes one or more low voltage wiring diagrams for the home that illustrate the home networking system infrastructure. Specifically, the low voltage wiring diagrams identify the location within the home of a network connection center from which various communications cables are to be distributed throughout the home. In addition, the low voltage wiring diagrams include the locations and types of outlets within the various rooms of the home and at which a respective communications cable routed from the network connection center terminates.

To assist a homeowner in selecting options, the workbook may include price lists for the available home networking system options that are supported by the home networking system infrastructure. The workbook may also include various other information that can be helpful to a homeowner is selecting options and coordinating installation of a custom home networking system.

The intermediary allows a homeowner to select one or more home networking system options from the workbook to produce a custom home networking system for the home (Block 230). The intermediary then produces a revised set of low voltage wiring diagrams illustrating a home networking system infrastructure necessary to support the custom home networking system for the home (Block 240). For example, the homeowner may not choose a device or system to be connected to every possible outlet set forth in the initial low voltage wiring diagrams.

The intermediary may act on behalf of the homeowner and coordinate installation of the custom home networking system with an installer (Block 250). The intermediary may also monitor installation of the custom home networking system for compliance with regulations and standards, and/or with established schedules (Block 260).

Upon installation of a custom home networking system, the intermediary may facilitate the activation of components and/or services of the custom home networking system (Block 270). The intermediary may also provide a homeowner with an owner's manual for a custom home networking system that provides various information (e.g., operational information, warranty information, trouble shooting information, etc.) about the custom home networking system (Block 280).

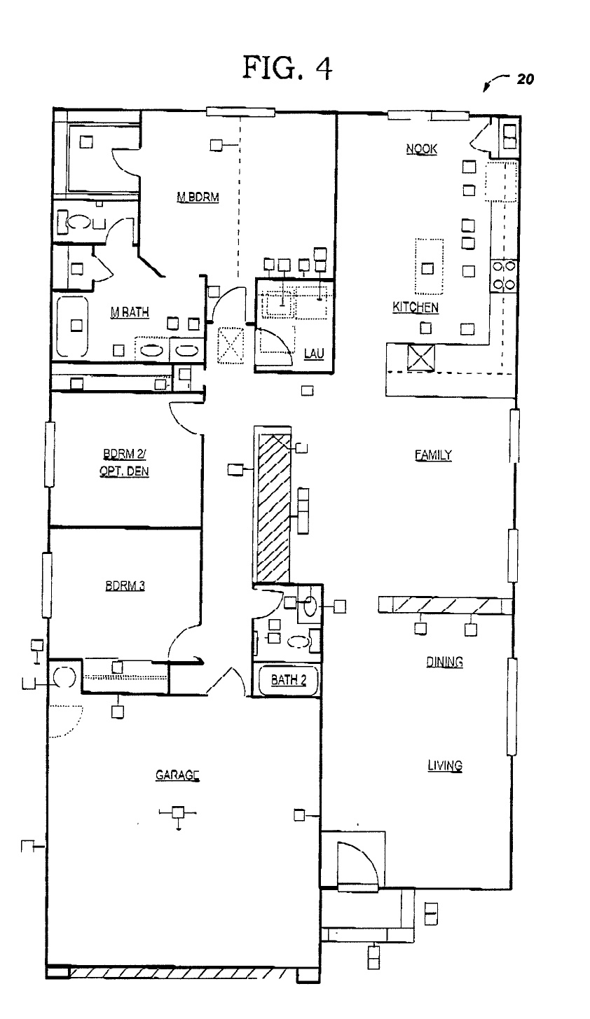

Referring now to FIG. 4, a floor plan 20 for a portion of a home is illustrated. The illustrated floor plan 20 sets forth the physical layout and dimensions of various rooms in a particular home. In addition, the locations of windows, doors, appliances, and various fixtures are indicated. Floor plans are well understood by those of skill in the art and need not be described further herein. It is understood that the term “floor plans”, as used herein, may include various materials and drawings used in the construction and/or remodeling of, homes and other structures, and are not limited to the illustrated floor plans of FIG. 4.

From a floor plan, such as the one illustrated in FIG. 4, an intermediary can obtain various objective and subjective information for use in designing a home networking system infrastructure. Exemplary objective information that may be obtained from the illustrated floor plan 20 includes the number of rooms, the number of windows and doors in each room, the physical dimensions of the rooms, and the locations of various appliances and fixtures to be installed within the home. Exemplary subjective information that may be obtained from the floor plan 20 includes recognition that the kitchen for the home is adjacent to the master bedroom, and that the second bedroom may be optionally utilized as a den.

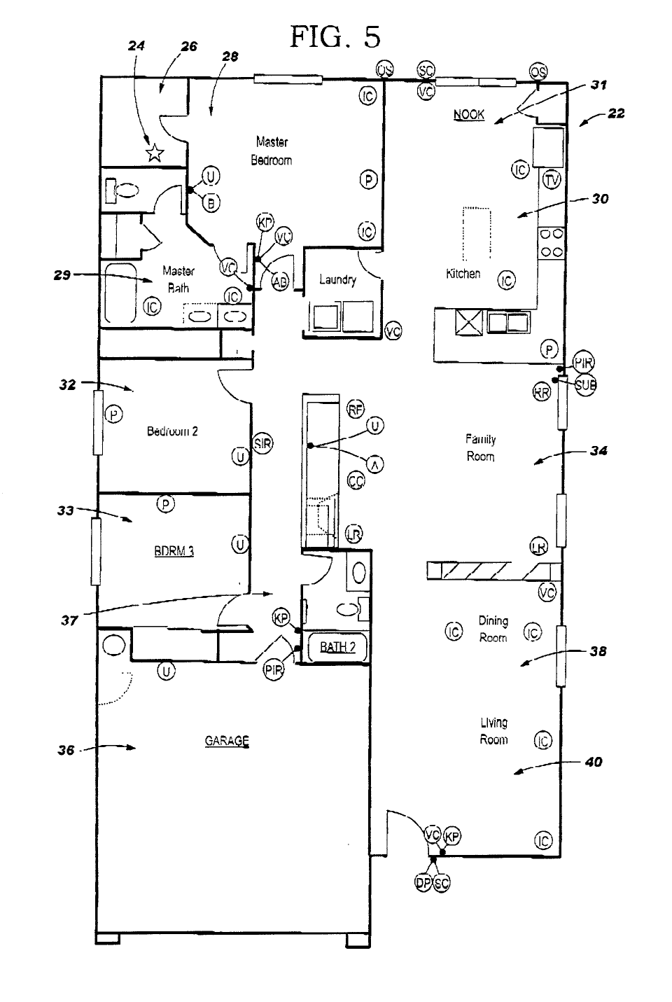

The information obtained from the floor plan 20 of FIG. 4 is then used by the intermediary in designing a home networking system infrastructure for the home that can support various home networking system options selected by the homeowner. FIG. 5 is a low voltage wiring diagram 22 that schematically represents a home networking system infrastructure for the floor plan 20 of FIG. 4. In the illustrated low voltage wiring diagram 22, the identity and location of various outlets and devices are provided. Each outlet or device is the termination point for a respective communications cable that extends from a network connection center 24.

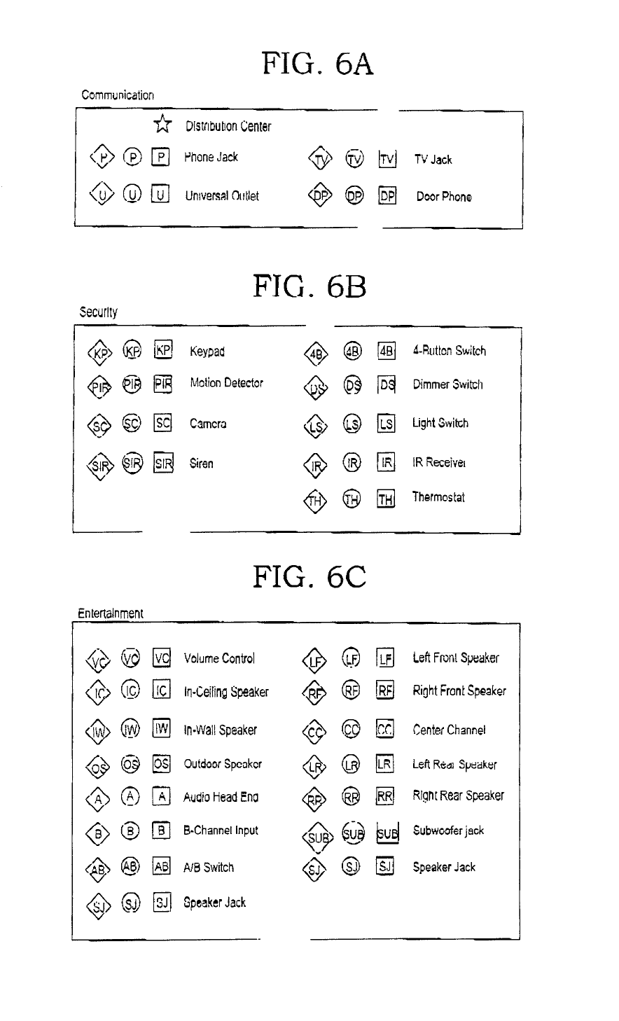

FIGS. 6A-6C provide keys for the various types of outlets and devices associated with the home networking system infrastructure of FIG. 4. FIG. 6A provides a key for outlets and devices associated with communications options for a home networking system. FIG. 6B provides a key for devices associated with security options for a home networking system. FIG. 6C provides a key for outlets and devices associated with entertainment options for a home networking system. In FIGS. 6A-6C, squares indicate that outlets and/or devices are standard for a particular home, diamonds indicate that outlets and/or devices are pre-wired for a particular home, and circles indicate that outlets and/or devices are optional for a particular home.

For example, in the home networking system infrastructure illustrated in FIG. 5, a network connection center 24 is located within a walk-in closet 26 connected to the master bedroom 28. Various telecommunications and entertainment services are run to the network connection center 24 from service providers. For example, cable television is provided to the network connection center 24 from a service provider. Telephone service may also be provided to the network connection center 24 from a service provider. Services provided to the network connection center 24 are then distributed to various locations within the home via communications cables.

In the illustrated home networking system infrastructure, telephone service is distributed to phone jacks (indicated by “P”) in the master bedroom 28, the kitchen 30, and the two additional bedrooms 32, 33. Various services (e.g., telephone, data, television, and video) may be distributed to the universal outlets (indicated by “U”) in the master bedroom 28, the two additional bedrooms 32, 33, the family room 34, and the garage 36. Television service is distributed to the TV jack (indicated by “TV”) in the kitchen 30. Door phone service is distributed to the phone jack (indicated by “DP”) on the outside wall of the living room 40, adjacent the entry.

In-ceiling speakers (indicated by “IC”) are located in the master bedroom 28, the master bath 29, the kitchen 30, the dining room 38, and the living room 40. In-room speakers (indicated by “RF”, “CC”, “LF”, “RR”, “LR”) are located in the family room 34. Outside speakers (indicated by “OS”) are located on the outside wall of the nook 31. Music and/or other types of audio content is delivered to the various speakers from the network connection center 24. Controls for the various speakers are also located throughout the home. For example, volume controls (indicated by “VC”) are located in the master bedroom 28, the master bath 29, the kitchen 30, the nook 31, the dining room 38, and the living room 40. Wires associated with the volume controls are distributed to the various volume controls from the network connection center 24.

In the illustrated home networking system infrastructure, security cameras (indicated by “SC”) are located on the outside walls of the nook 31, and the living room 40. Motion detectors (indicated by “PIR”) are located in the family room 34, and the hall 37 leading to the garage 36. Security system keypads (indicated by “KP”) are located in the master bedroom 28, the living room 40, and the hall 37 leading to the garage 36. A siren (indicated by “SIR”) is located in the hall 37 leading to the garage 36. Wires associated with the security system are distributed to the various security system components from the network connection center 24.

Once a home networking system infrastructure is designed, the intermediary prepares one or more home networking system options (or packages) for communications, entertainment, and security systems, from which a homeowner can select. Various home networking system options are listed below in Tables 1-4.

Table 1 includes various options (packages) that a homeowner can select for a communications system portion of a custom home networking system. Table 2 includes various options (packages) that a homeowner can select for a surround sound (entertainment) system portion of a custom home networking system. Table 3 includes various options (packages) that a homeowner can select for a multi-room music (entertainment) system portion of a custom home networking system.

Table 4 includes various options (packages) that a homeowner can select for a security system portion of a custom home networking system. The various options represented by Tables 1-4 may be presented to a homeowner (or potential homeowner) in the form of a workbook (also referred to as a “Welcome Package”), as described above.

TABLE 1
COMMUNICATION PACKAGES

| Features | Starter | Basic | Expanded | Total |
|---|---|---|---|---|
| Home Director | Standard | Standard | Standard | Standard |
| Network | | | | |
| Connection | | | | |
| Center | | | | |
| Universal | Family | Family | Family | Family |
| Outlets² (1 | Room | Room; | Room; | Room; |
| telephone jack, | | Bedrooms | Bedrooms | Bedrooms |
| 1 data port, 2 | | (or | (or | (or |
| cable | | equivalent) | equivalent) | equivalent) |
| connections) | | | | |

TELEPHONE FEATURES

| Phone | Bedrooms; | Bedrooms; | Bedrooms; | Bedrooms; |
|---|---|---|---|---|
| Outlets | Kitchen | Kitchen | Kitchen | Kitchen |
| 4 Phone lines | 4 × 8 | 4 × All | 4 × All | 4 × All |
| Front Door | N/A | Standard | Standard | Standard |
| Intercom | | | | |
| Pre-wire | | | | |
| Front Door | N/A | Optional | Optional | Standard |
| Intercom | | | | |
| System | | | | |

VIDEO FEATURES

| TV Outlet | Bedrooms | Kitchen | Kitchen | Kitchen |
|---|---|---|---|---|
| Local | Standard | Standard | Standard | Standard |
| Antenna Pre- | | | | |
| wire | | | | |
| Local | Optional | Optional | Standard | Standard |
| Antenna | | | | |
| DIRECTV | Standard | Standard | Standard | Standard |
| Pre-wire | | | | |
| DIRECTV | Optional | Optional | Standard | Standard |
| System | | | | |
| Video | Unamplified; | Amplified; | Amplified; | Amplified; |
| Distribution | 1 × 4 | 8 × 8 | 1 × 6 | 8 × 8 |
| inputs × | | | | |
| outputs | | | | |
| 3 × 8 | Optional | Optional | Standard | Standard |
| Multiswitch | | | | |
| 1-Channel | N/A | N/A | Standard | Standard |
| Modulator | | | | |

COMPUTER NETWORKING

| | | | | |
|---|---|---|---|---|
| 8-Port | N/A | Standard | Standard | Standard |
| Ethernet hub | | | | |
| 8-Port | N/A | Optional | Optional | Optional |
| Ethernet | | | | |
| Switch | | | | |

MISCELLANEOUS

| | | | | |
|---|---|---|---|---|
| AC Power | N/A | N/A | Standard | Standard |
| Distribution | | | | |
| Front | N/A | Standard | Standard | Standard |
| Door/Backyard | | | | |
| Safety | | | | |
| Camera pre- | | | | |
| wire | | | | |
| Front | N/A | Optional | Optional | Standard |
| Door/Backyard | | | | |
| Safety | | | | |
| Cameras | | | | |
| Additional | Optional | Optional | Optional | Optional |
| Universal | | | | |
| Outlet (s) | | | | |
| Customer | Standard | Standard | Standard | Standard |
| Orientation | | | | |
| Price | See Price | See Price | See Price | See Price |
| | List | List | List | List |

TABLE 2
SURROUND SOUND PACKAGES

| | | Basic | Expanded | Total |
|---|---|---|---|---|
| Features | Pre-Wire | Package | Package | Package |
| Left & Right | Standard | Standard | Standard | Standard |
| Front Speaker | | | | |
| Pre-Wire | | | | |
| Center Channel | Standard | Standard | Standard | Standard |
| Pre-W ire | | | | |
| Left & right Rear | Standard | Standard | Standard | Standard |
| Speaker Pre- | | | | |
| Wire | | | | |
| Subwoofer Pre- | Standard | Standard | Standard | Standard |
| Wire | | | | |
| Media Alcove | N/A | Standard | Standard | Standard |
| Speaker Jacks | (blank | | | |
| | plate | | | |
| | included) | | | |
| Subwoofer | N/A | Standard | Standard | Standard |
| Speaker Jacks | (blank | | | |
| | plate | | | |
| | included) | | | |
| Left & Right | N/A | 6.5″, entry- | 6.5″, mid- | 6.5″, |
| Front Speakers | | level | level | “Reference” |
| | | speakers | speakers | quality |
| | | | | speaker |
| Center Channel | N/A | 6.5″, entry- | 6.5″, mid- | 6.5″, |
| Speaker | | level | level | “Reference” |
| | | speakers | speakers | quality |
| | | | | speaker |
| Left & Right | N/A | 6.5″, entry- | 6.5″, mid- | 6.5″, |
| Rear Surround | | level | level | “Reference” |
| Speakers | | speakers | speakers | quality |
| | | | | speaker |
| Location | Family | Family | Family | Family |
| | Room | Room | Room | Room |
| Rear Speaker | Optional | N/A | N/A | N/A |
| Trim (6.5″, mid- | | | | |
| level rear | | | | |
| speakers, media | | | | |
| alcove jack and | | | | |
| subwoofer jack) | | | | |
| Price | See Price | See Price | See Price | See Price |
| | List | List | List | List |

TABLE 3
MULTI-ROOM MUSIC PACKAGES

| | | Basic | Expanded | Total |
|---|---|---|---|---|
| Features | Pre-Wire | Package | Package | Package |
| Speaker Pre- | Standard | Standard | Standard | Standard |
| Wire (to volume | | | | |
| control, each | | | | |
| zone) | | | | |
| Volume Control | Standard | Standard | Standard | Standard |
| Pre-Wire (to | | | | |
| volume control, | | | | |
| each zone) | | | | |
| Speaker | Standard | Standard | Standard | Standard |
| Distribution | | | | |
| Module | | | | |
| Speaker Input | N/A | Standard | Standard | Standard |
| Jacks (A-channel | | | | |
| input | | | | |
| Speaker Input | N/A | Standard | Standard | Standard |
| Jacks (B-channel | | | | |
| input) | | | | |
| Volume Control | N/A | Standard | Standard | Standard |
| (in each zone) | | | | |
| Local A/B Switch | N/A | Standard | Standard | Standard |
| (in Master | | | | |
| Bedroom | | | | |
| Pair of Speakers | N/A | 6.5″, entry | 6.5:, mid- | 6.5:, |
| (located Master | | level | level | “Reference” |
| BR & | | speakers | speakers | quality |
| Entry/Living | | | | speakers |
| Room)^{1,2} | | | | |
| Additional Zone³ | Optional | Optional | Optional | Optional |
| Price | See Price | See Price | See Price | See Price |
| | List | List | List | List |

TABLE 4
SECURITY PACKAGES

| | Starter | Basic | Expanded | Total |
|---|---|---|---|---|
| Features | Security | Security | Security | Security |
| Exterior Doors | Pre-Wire & | Pre-Wire & | Pre-Wire & | Pre-Wire & |
| | Contact | Contact | Contact | Contact |
| | Protected | Protected | Protected | Protected |
| Operable | N/A | Pre-Wire & | Pre-Wire & | Pre-Wire & |
| Windows | | Contact | Contact | Contact |
| | | Protected | Protected | Protected |
| Alarm Panel | 8-Zone, | 8-Zone, | 16-Zone, | 32-Zone, |
| | Standard | Standard | Standard | Standard |
| Motion | One | One | One | One |
| Detector(s) | Downstairs | Downstairs | Downstairs | Downstairs; |
| | | | | One Upstairs |
| Backup Security | Standard | Standard | Standard | Standard |
| Alarm Keypad(s) | One LED, | One LED, | One LCD, | One LCD, |
| | Standard | Standard | Standard | Standard |
| Siren/Bell | One | One Indoor | One Indoor & | One Indoor & |
| | Indoor | | One Outdoor | One Outdoor |
| Wireless Panic | N/A | Optional | Standard | Standard |
| | | Optional | Optional | Standard |
| Programming | Standard | Standard | Standard | Standard |
| 2 Year Security | 1st Year | 1st Year | 1st Year | 1st year |
| Monitoring | Included | Included | Included | Included |
| Agreement | | | | |
| Additional Alarm | Optional | Optional | Optional | Optional |
| Keypad | | | | |
| Additional | Optional | Optional | Optional | Optional |
| Motion Detector | | | | |

The intermediary may also prepare a proposal for a builder that includes a description of a home networking system infrastructure for a particular home design (e.g., for a particular set of floor plans) and that includes available options that can be selected by individual homeowners. For example, Tables 5-8 below provide information about the various communications system options that a homeowner can select for the home

TABLE 5
Digital Age ™ Wiring Network-Basic DAWN ™

| Qty | Description | Wiring | Location |
|---|---|---|---|
| 1 | Universal Outlet | Dual RG-6, Dual | Family Room |
| | | CAT-5 | |
| “X” | Telephone Outlets | CAT-5 | Bedrooms (Den, |
| | | | Loft, Retreat, |
| | | | Bonus, etc.), Family |
| | | | Room |
| “X” | TV Outlets | Single RG-6 | Bedrooms (Den, |
| | | | Loft, Retreat, |
| | | | Bonus, etc.), Family |
| | | | Room |
| 1 | DAWN ™ Phone and | | CDP |
| | Cable Distribution | | |
| | Panel | | |
| 1 | Telco and Cable | Dual RG-6, Dual | POE to CDP |
| | Service Run | CAT-5 | |
| 1 | DirecTV Pre-wire with | Two Dual RG-6 | POE to CDP |
| | Service Box and | | |
| | Cover | | |
| 1 | UHF/VHF/FM/HDTV | Single RG-6 | POE to CDP |
| | Pre-Wire with | | |
| | Antenna Box and | | |
| | Cover | | |
| 1 | Customer Orientation | | |

TABLE 6
Digital Age ™ Wiring Network-Expanded DAWN ™

| Qty | Description | Wiring | Location |
|---|---|---|---|
| 1 | Universal Outlets | Dual RG-6, Dual | Bedrooms (Den, |
| | | CAT-5 | Loft, Retreat, |
| | | | Bonus, etc.), Family |
| | | | Room |
| “X” | Telephone Outlets | Single CAT-5 | Bedrooms (Den, |
| | | | Loft, Retreat, |
| | | | Bonus, etc.), Family |
| | | | Room |
| 1 | Kitchen TV Outlet | Single RG-6 | Kitchen |
| 1 | DAWN ™ Phone and | | CDP |
| | Cable Distribution | | |
| | Panel | | |
| 1 | Telco and Cable | Dual RG-6, Dual | POE to CDP |
| | Service Rum | CAT-5 | |
| 1 | DirecTV Pre-Wire | Two Dual RG-6 | POE to CDP |
| | with Service Box and | | |
| | Cover | | |
| 1 | UHF/VHF/FM/HDTV | Single RG-6 | POE to CDP |
| | Pre-Wire with | | |
| | Antenna Box and | | |
| | Cover | | |
| 1 | 5-Port Ethernet Hub | | Central Distribution |
| | | | Point |
| 1 | Front Door Intercom | Single CAT-5 | Front Entry |
| | Pre-Wire | | |
| 2 | Security Camera Pre- | One CAT-5, One | Front Entry and |
| | Wires | RG-6 | Back Yard |
| 1 | Customer Orientation | | |

TABLE 7
Digital Age ™ Wiring Network-Total DAWN ™

| Qty | Description | Wiring | Location |
|---|---|---|---|
| “X” | Universal Outlets | Dual RG-6, Dual | Bedrooms (Den, |
| | | CAT-5 | Loft, Retreat, |
| | | | Bonus, etc.), Family |
| | | | Room |
| “X” | Telephone Outlets | Single CAT-5 | Bedrooms (Den, |
| | | | Loft, Retreat, |
| | | | Bonus etc.), Family |
| | | | Room |
| 1 | Kitchen TV Outlet | Single RG-6 | Kitchen |
| 1 | DAWN ™ Phone and | | CDP |
| | Cable Distribution | | |
| | Panel | | |
| 1 | Telco and Cable | Dual RG-6, dual | POE to CDP |
| | Service Rum | CAT-5 | |
| 1 | DirecTV Pre-Wire | Two Dual RG-6 | POE to CDP |
| | with Service Box and | | |
| | Cover | | |
| 1 | UHF/VHF/FM/HDTV | Single RG-6 | POE to CDP |
| | Pre-Wire with | | |
| | Antenna Box and | | |
| | Cover | | |
| 1 | 5-Port Ethernet Hub | | Central Distribution |
| | | | Point |
| 1 | Single Channel | | Media Niche |
| | Audio/Video | | |
| | Modulator | | |
| 1 | Front Door Intercom | Single CAT-5 | Front Entry |
| | Pre- Wire | | |
| 2 | Security Camera Pre- | One CAT-5, One | Front Entry and |
| | Wires | RG-6 | Back Yard |
| 1 | Customer Orientation | | |

TABLE 8
Digital Age ™ Wiring Network-Total DAWN ™ Plus

| Qty | Description | Wiring | Location |
|---|---|---|---|
| “X” | Universal Outlets | Dual RG-6, Dual | Bedrooms (Den, |
| | | CAT-5 | Loft, Retreat, |
| | | | Bonus, etc.), Family |
| | | | Room |
| “X” | Telephone Outlets | Single CAT-5 | Bedrooms (Den, |
| | | | Loft, Retreat, |
| | | | Bonus, etc.), Family |
| | | | Room |
| 1 | Kitchen TV Outlet | Single RG-6 | Kitchen |
| 1 | DAWN ™ Phone and | | CDP |
| | Cable Distribution | | |
| | Panel | | |
| 1 | Telco and Cable | Dual RG-6, Dual | POE to CDP |
| | Service Run | CAT-5 | |
| 1 | DirecTV Pre-Wire | Two Dual RG-6 | POE to CDP |
| | with Service Box and | | |
| | Cover | | |
| 1 | UHF/VHF/FM/HDTV | Single RG-6 | POE to CDP |
| | Pre-Wire with | | |
| | Antenna Box and | | |
| | Cover | | |
| 1 | DirecTV Satellite | | Media Niche |
| | System | | |
| 1 | 5-Port Ethernet Hub | | Central Distribution |
| | | Point | |
| 1 | Single Channel | | Media Niche |
| | Audio/Video | | |
| | Modulator | | |
| 1 | Front Door Intercom | Single CAT-5 | Front Entry |
| | System | | |
| 2 | Security Cameras | One CAT-5, One | Front Entry and |
| | | RG-6 | Back Yard |
| 1 | Customer Orientation | | |

Tables 9-16 below provide information about the various security system options that a homeowner can select for the home design of FIG. 4.

TABLE 9
Basic Security Pre-Wire

| Qty | Description | Wiring | Location |
|---|---|---|---|
| All | Pre-Wire Exterior | 22 Gauge/2 | All Exterior Doors |
| | Doors | Conductor | |
| 1 | Pre-Wire Alarm | 18 Gauge/4 | Garage Entry |
| | Keypad | Conductor | |
| 1 | Pre-Wire Motion | 22 Gauge/4 | Family Room |
| | Detector | Conductor | |
| 1 | Pre-Wire Siren | 18 Gauge/4 | Hallway |
| | | Conductor | |

TABLE 10
Total Security Pre-Wire

| Qty | Description | Wiring | Location |
|---|---|---|---|
| All | Pre-Wire Exterior | 22 Gauge/2 | All |
| | Doors and Operable | Conductor | |
| | Windows | | |
| 3 | Pre-Wire Alarm | 18 Gauge/4 | Garage Entry, |
| | Keypad | Conductor | Master Bedroom, |
| | | | Front Entry |
| 2 | Pre-Wire Motion | 22 Gauge/4 | Family Room |
| | Detector | Conductor | |
| 2 | Pre-Wire Siren | 18 Gauge/4 | Hallway, Exterior |
| | | Conductor | |

TABLE 11
Fire Safety Pre-Wire (Included with Total Security Pre-Wire)

| Qty | Description | Wiring | Location |
|---|---|---|---|
| 1 | Pre-Wire Smoke/ | 18 Gauge/4 | Hallway |
| | Heat Detector | Conductor | |
| 2 | Pre-Wire Heat | 18 Gauge/4 | Kitchen, Garage |
| | Detector | Conductor | |
| 1 | Pre-Wire Sprinkler | 18 Gauge/4 | Sprinkler Panel |
| | Flow Switch Contact | Conductor | |

TABLE 12
Basic Security System

| Qty | Description | Location |
|---|---|---|
| 1 | Basic Security Pre-Wire | |
| All | Lower level exterior doors | |
| | contact protected | |
| 1 | Basic 8-zone alarm panel with | Master Bedroom Closet |
| | power supply | |
| 1 | Interior room protected with pet | Family Room |
| | resistant motion detector | |
| 1 | Backup Battery | |
| 1 | 8-zone Led Alarm Keypad | Garage Entry |
| 1 | Indoor Siren | Hallway |

TABLE 13
Expanded Security System

| Qty | Description | Location |
|---|---|---|
| 1 | Expanded Security Pre-Wire | |
| All | Exterior doors and Windows | |
| | contact protected | |
| 1 | Basic 8-zone alarm panel with | Master Bedroom Closet |
| | power supply | |
| 1 | Interior room protected with pet | Family Room |
| | resistant motion detector | |
| 1 | Backup Battery | |
| 1 | 8-Zone LED Alarm Keypad | Garage Entry |
| 1 | Indoor Siren | Hallway |

TABLE 14
Total Security System

| Qty | Description | Location |
|---|---|---|
| 1 | Total Security Pre-Wire | |
| All | Exterior Doors and Windows | |
| | contact protected | |
| 1 | 16-zone alarm panel with power | Master Bedroom Closest |
| | supply | |
| 1 | Interior room protected with pet | Family Room |
| | resistant motion detector | |
| 1 | Backup Battery | |
| 1 | LCD Alarm Keypad | Garage Entry |
| 1 | Wireless Panic Button | |
| 1 | Indoor Siren | Hallway |
| 1 | Outdoor Siren | Attic |

TABLE 15
Total Security System Plus

| Qty | Description | Location |
|---|---|---|
| 1 | Total Security Pre-Wire | |
| All | Exterior Doors and Windows | |
| | contact protected | |
| 1 | 32-zone alarm panel with power | Master Bedroom Closet |
| | supply | |
| 2 | Interior room protected with pet | Family Room, Living Room |
| | resistant motion detector | |
| 1 | Backup Battery | |
| 2 | LCD Alarm Keypad | Garage Entry, Master Bedroom, |
| | | or Front Entry |
| 1 | Telephone Interface Module | |
| 1 | Wireless Panic Button | |
| 1 | Indoor Siren | Hallway |
| 1 | Outdoor Siren | Attic |

TABLE 16
Fire Security System

| Qty | Description | Location |
|---|---|---|
| 1 | Smoke/Heat Detector | Hallway |
| 2 | Heat Detectors | Kitchen, Garage |
| 1 | Connection to Existing Sprinkler | Sprinkler Panel |
| | Flow Switch Contact | |

Tables 17-20 below provide information about the various multi-room music (entertainment) system options that a homeowner can select for the home design of FIG. 4.

TABLE 17
Multi-Room Music-Pre-Wire Only

| Qty | Description | Wiring | Location |
|---|---|---|---|
| 1 | Speaker Distribution | | Media Niche |
| | Module | | |
| 1 | Audio Cable to | 16 Gauge/4 | Master Bedroom, |
| | Distribution Module | Conductor | Living Room |
| 1 | Control Cable to | 22 Gauge/2 Pair | Master Bedroom, |
| | Distribution Module | Shield | Living Room |
| 1 | Audio Cable to | 16 Gauge/2 | Master Bedroom, |
| | Speakers | Conductor | Living Room |

TABLE 18
Basic Multi-Room Music System

| Qty | Description | Location |
|---|---|---|
| 1 | Multi-Room Pre-Wire (above) | |
| 1 | Local A/B Wall Switch | Master Bedroom |
| 1 | Left and Right Speaker Input | Next to Universal outlet in |
| | jack | Master Bedroom |
| 2 | Impedance Matching Volume | Master Bedroom, Living |
| | Control | Room |
| 2 Pr. | 6.5″ Klipsch ® Contractor Series | Master Bedroom, Living |
| | In-Ceiling or In-Wall Speakers | Room |

TABLE 19
Total Multi-Room Music System

| Qty | Description | Location |
|---|---|---|
| 1 | Multi-Room Pre-Wire (above) | |
| 1 | Local A/V Wall Switch | Master Bedroom |
| 1 | Left and Right Speaker Input | Next to Universal outlet in |
| | Jack | Master Bedroom |
| 2 | Impedance Matching Volume | Master Bedroom, Living Room |
| | Control | |
| 2 Pr. | 6.5″ Klipsch ® Synergy Series | Master Bedroom, Living Room |
| | In-Ceiling or In-Wall Speakers | |

TABLE 20
Total Plus Multi-Room Music System

| Qty | Description | Location |
|---|---|---|
| 1 | Multi-Room Pre-Wire (above) | |
| 1 | Local A/B Wall Switch | Master Bedroom |
| 1 | Left and Right Speaker Input | Next to Universal outlet in |
| | jack | Master Bedroom |
| 2 | Impedance Matching Volume | Master Bedroom, Living |
| | Control | Room |
| 2 Pr. | 6.5″ Klipsch ® Reference Series | Master Bedroom, Living |
| | In-Ceiling or In-Wall Speakers | Room |

Tables 21-24 below provide information about the various surround sound music (entertainment) system options that a homeowner can select for the home design of FIG. 4.

TABLE 21
Surround Sound - Pre-Wire

| Qty | Description | Location |
|---|---|---|
| 1 | Left front, Right front and | Family Room |
| | Center In-ceiling or In-wall | |
| | speaker Pre-Wire | |
| 1 | Subwoofer Pre-Wire | Family Room |
| 1 | Left rear and right rear In- | Family Room |
| | ceiling speaker pre-wire | |
| 1 | Subwoofer blank single-gang | At Subwoofer |
| | plate installed at outlet level | |
| 1 | Media alcove blank double-gang | Media Niche |
| | plate | |

TABLE 22
Basic Surround Sound Speaker System

| Qty | Description | Location |
|---|---|---|
| 1 | Surround Sound Pre-Wire | Family Room |
| | (above) | |
| 1 | Left and Right Front, Left and | Family Room |
| | Right Rear, and Center Channel | |
| | 6.5″ In-ceiling or In-wall | |
| | surround sound Klipsch ® | |
| | Contractor speakers installed | |
| 1 | Media alcove speaker jacks | Family Room |

TABLE 23
Total Surround Sound Speaker System

| Qty | Description | Location |
|---|---|---|
| 1 | Surround Sound Pre-wire | Family Room |
| | (above) | |
| 1 | Left and Right Front, Left and | Family Room |
| | Right Rear, and Center Channel | |
| | 6.5″ In-ceiling or In-wall | |
| | surround sound Klipsch ® | |
| | Synergy Series speakers | |
| | installed | |
| 1 | Media alcove speaker jacks | Family Room |

TABLE 24
Total Surround Sound Plus Speaker System

| Qty | Description | Location |
|---|---|---|
| 1 | Surround Sound Pre-wire | Family Room |
| | (above) | |
| 1 | Left and Right Front, Left and | Family Room |
| | Right Rear, and Center Channel | |
| | 6.5″ In-ceiling/In-wall surround | |
| | sound Klipsch ® Reference | |
| | Series speakers installed | |
| 1 | Media alcove speaker jacks | Family Room |

A proposal prepared for a builder may also include cost information and a bill of materials for various options or packages that a homeowner can select for a particular home.

The intermediary may prepare a homeowner's manual that provides information about how the various portions of the custom home networking system operate, warranty information, and how to obtain service help.

The foregoing is illustrative of the present invention and is not construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of facilitating the design and installation of a custom home networking system within a home to be constructed by a builder, the method comprising:
obtaining information from floor plans for the home;
designing a home networking system infrastructure for the home using information obtained from the floor plans, wherein the home networking system infrastructure comprises a plurality of communications cables that extend from a network connection center to be located within the home and that terminate at respective outlets or devices to be located in one or more rooms of the home, and wherein the home networking system infrastructure is configured to support various home networking system options;
producing a work book that comprises a description of various home networking system options that are supported by the home networking system infrastructure, wherein home networking system options comprise telecommunications options, and/or entertainment options, and/or security options; and
allowing a user to select home networking system options from the workbook to produce a custom home networking system for the home.

2. The method according to claim 1, wherein obtaining information from the floor plans comprises obtaining objective and subjective information about the home, wherein subjective information comprises information interpreted by the intermediary as being relevant to a custom home networking system for the home, and wherein objective information comprises information associated with measurable, physical parameters in the floor plans.

3. The method according to claim 1, wherein the workbook further comprises a set of low voltage wiring diagrams for the home, wherein the set of low voltage wiring diagrams identifies a location of a network connection center and locations and types of outlets and devices in the home networking system infrastructure.

4. The method according to claim 3, wherein the workbook further comprises a price list for the available home networking system options described therewithin.

5. The method according to claim 1, further comprising providing the builder with cost information associated with installing the custom home networking system.

6. The method according to claim 1, wherein providing the builder with cost information comprises providing the builder with a bill of materials and a price list for the custom home networking system.

7. The method according to claim 1, further comprising integrating a schedule for installing the custom home networking system into the builder's construction schedule for the home.

8. The method according to claim 1, further comprising monitoring installation of the custom home networking system for the home.

9. The method according to claim 1, further comprising facilitating the activation of components and/or services of the custom home networking system after installation thereof.

10. The method according to claim 1, further comprising providing the user with an owner's manual for the custom home networking system that provides operational information about the custom home networking system.

11. A method of facilitating the design of a custom home networking system for a home, comprising:
obtaining information from floor plans for the home;
designing a home networking system infrastructure for the home using information obtained from the floor plans, wherein the home networking system infrastructure comprises a plurality of communications cables that extend from a network connection center to be located within the home and that terminate at respective outlets or devices to be located in one or more rooms of the home, and wherein the home networking system infrastructure is configured to support various home networking system options;
producing a work book that comprises a description of various home networking system options that are supported by the home networking system infrastructure, wherein home networking system options comprise telecommunications options, and/or entertainment options, and/or security options; and
allowing a user to select home networking system options from the workbook to produce a custom home networking system for the home.

12. The method according to claim 11, wherein obtaining information from the floor plans comprises obtaining objective and subjective information about the home, wherein subjective information comprises information interpreted by the intermediary as being relevant to a custom home networking system for the home, and wherein objective information comprises information associated with measurable, physical parameters in the floor plans.

13. The method according to claim 11, wherein the workbook further comprises a set of low voltage wiring diagrams for the home, wherein the set of low voltage wiring diagrams identifies a location of a network connection center and locations and types of outlets and devices in the home networking system infrastructure.

14. The method according to claim 13, wherein the workbook further comprises a price list for the available home networking system options described therewithin.

15. The method according to claim 11, further comprising facilitating the activation of components and/or services of the custom home networking system after installation thereof.

16. The method according to claim 11, further comprising providing the user with an owner's manual for the custom home networking system that provides operational information about the custom home networking system.
